(19) United States
(12) Patent Application Publication
(10) Pub. No.: US 2004/0228437 A1
(43) Pub. Date: Nov. 18, 2004

(54) In-situ monitoring system for bonding process and method therefor

(75) Inventors: Jong-sig Lee, Gyeonggi-do (KR); Gi-tae Mun, Gyeonggi-do (KR); Jae-cheol Lee, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/794,085

(22) Filed: Mar. 8, 2004

(30) Foreign Application Priority Data
May 15, 2003 (KR) 10-2003-0030898

(51) Int. Cl. G01N 23/06; G01N 23/02; G01T 3/00

(52) U.S. Cl. 378/58; 378/51

(57) ABSTRACT

An in-situ monitoring system for a bonding process and a method therefor are provided. The monitoring system includes: a light source irradiating rays to a sample; a heating unit heating the sample; a temperature detecting unit detecting the temperature of the sample; a light detecting unit detecting the rays passing through the sample and converting the rays into an image signal; and a controlling unit receiving and outputting the image signal, and transmitting a signal for controlling the light source and the heating unit.

### BACKGROUND OF THE INVENTION

This application claims the priority of Korean Patent Application No. 2003-30898, filed on May 15, 2003, in the Korean Intellectual Property Office, the disclosure of which is incorporated herein in its entirety by reference.

1. Field of the Invention

The present invention relates to a monitoring system for a bonding process and a method therefor, and particularly, to a monitoring system and a monitoring method by which a bonding process can be monitored in real time.

2. Description of the Related Art

In a general bonding process, after all procedures have been completed, a bonded portion is inspected using X-rays or an ultrasonic microscope. In this case, an inspection of a sample is simpler than an in-situ inspection during the bonding process, however, the result of the inspection is obtained only after completing all the procedures. Thus, it is impossible to deal with a defect rapidly, and a cause of the defect can not be removed during the bonding process. Therefore, device for monitoring the bonding process is required to solve the above problems.

FIG. 1 is a schematic view of a ball grid array (BGA) assembly having an X-ray inspection system, disclosed in U.S. Pat. No. 6,009,145. Referring to FIG. 1, the BGA includes an assembly system 10, a heater 12, an upper heating plate 14, a lower heating plate 16, a BGA package 18, a circuit board 20, an X-ray tube 22 which generates X-rays 24, a beam limiter 23, a fluorescent imager 26 which outputs an image signal 28, a mirror 30, a video camera system 32, a lens 34, an extender 36, a camera body 38, and a video monitor 42 on which a video image signal 40 is displayed.

The X-rays 24 emitted from the X-ray tube 22 are restricted by the beam limiter 23 to focus on the BGA package 18 which contacts the circuit board 20. The X-rays 24 passing through the upper heating plate 14 selectively excite electrons of phosphor to have different energy states when passing through the fluorescent imager 26 to form the image signal 28. The image signal 28 is reflected by the mirror 30 and enlarged to be formed as the video image signal 40 after passing through the video camera system 32 including the lens 34, the extender 36 and the camera body 38. Then, the video image signal 40 is transmitted to the video monitor 42 and displayed to a user.

Since in the above system 10 a plurality of heating plates are needed, the structure of the system 10 is complicated, and heat is lost on entire surfaces of the upper and lower heating plates 14 and 16. Therefore, the system 10 has a heat loss greater than that of a system in which the bonded portion is locally heated. Also, the fluorescent imager 28 does not have high resolving power, and the discrimination is lowered because there is no reference data in determining whether there is a defect.

### SUMMARY OF THE INVENTION

The present invention provides a monitoring system of high resolving power and a method therefor by which a bonded status can be monitored in real-time.

According to an aspect of the present invention, there is provided an in-situ monitoring system comprising: a light source which irradiates light rays to a sample; a heating unit which heats the sample; a temperature detecting unit which detects the temperature of the sample; a light detecting unit which detects the light rays passing through the sample and converts the light rays into an image signal; and a controlling unit which receives and outputs the image signal, and transmits a signal for controlling the light source and the heating unit.

The light source may emit X-rays or ultrasonic waves. The heating unit may be a laser, a hot wire, or a heating plate. The temperature detecting unit may be a pyrometer or a thermocouple. The light detecting unit may be a fluorescence single crystal plate, and the controlling unit is a computer. Here, the monitoring system may further comprise a supporter for supporting the substrate, and a heat storage unit surrounding the sample.

According to another aspect of the present invention, there is provided an in-situ monitoring method comprising: (a) irradiating light rays to a sample, and bonding the sample to a substrate by heating the sample; and (b) detecting and reflecting the light rays passing through the sample, and monitoring the bonding status by detecting intensity of the light rays and temperature of the sample.

The monitoring method may further comprise: (c) controlling the intensity of the light rays and the temperature of sample after monitoring the bonding status in operation (b). The light rays may be X-rays or ultrasonic waves.

Operation (b) may further comprise: comparing the temperature of sample to a reference temperature when the intensity of the light rays is smaller than the reference intensity, and moving the sample outward and cooling the sample when the intensity of the light rays is larger than the reference intensity; and repeating operation (a) when the temperature of the sample is lower than the reference temperature, and moving the sample outward and discarding the sample when the temperature of the sample is higher than the reference temperature.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a ball grid array (BGA) assembly having an X-ray inspection system disclosed in U.S. Pat. No. 6,009,145;

FIG. 2 is a block diagram of a monitoring system for a bonding process, according to an embodiment of the present invention;

FIG. 3 is a block diagram of a monitoring system for a bonding process, according to an embodiment of the present invention;

FIG. 4A is a photograph of a heat storage unit in the monitoring system of FIG. 3;

FIG. 4B is a photograph of a light detecting unit and a second charge-coupled device (CCD) camera in the monitoring system of FIG. 3;

FIGS. 5A through 5D are photographs showing bonding states in a bonding process monitored in real-time using the monitoring system of FIG. 3;

FIGS. 6A through 7B are photographs showing bonding states of a bonding process monitored at a temperature of 280° C.; and

FIG. 8 is a flow chart illustrating a monitoring method for a bonding process, according to an embodiment of the present invention.

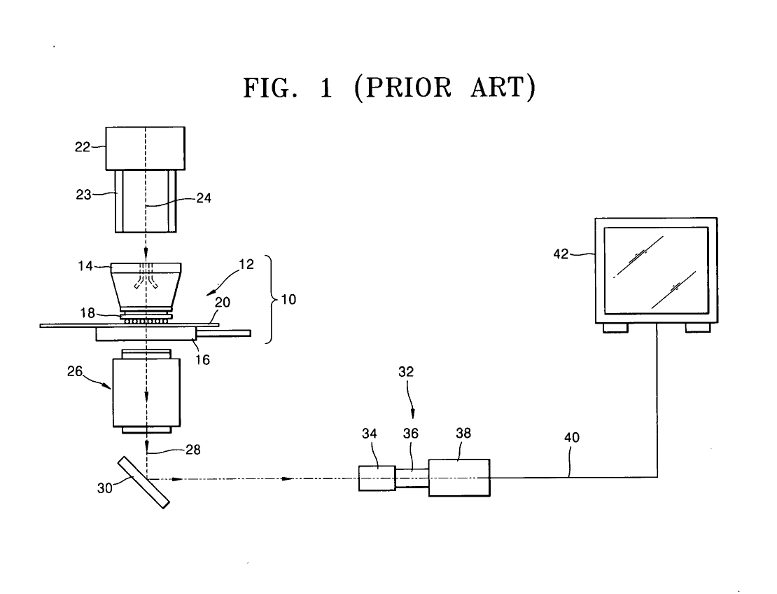

### DETAILED DESCRIPTION OF THE INVENTION

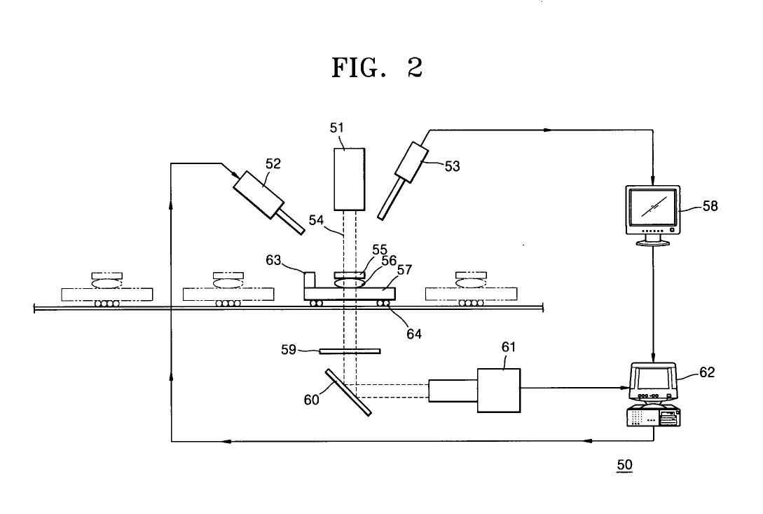

FIG. 2 is a block diagram of a monitoring system according to an embodiment of the present invention. Referring to FIG. 2, a monitoring system 50 comprises a light source 51, a heating unit 52, a temperature detecting unit 63, a light detecting unit 59, and a controlling unit 62, a supporter 64 for supporting a substrate 57, a first and second charge coupled device (CCD) cameras 53 and 61 for detecting a bonding status of a sample 55 to the substrate 57, and a mirror 60 disposed on a light path between the light detecting unit 59 and the second CCD camera 61 to change the light path.

The light source 51 irradiates a light ray 54 to the sample 55, and the heating unit 52 melts a solder 56 on the substrate 57 and heats the sample 55 so that the sample 55 is bonded on the substrate 57. The light ray 54 may be an X-ray or a ultrasonic wave. The X-ray is suitable for monitoring the bonding status on the bonded portion in real-time since it non-destructively passes through the sample 55 to be bonded. A laser, hot wire, or heating plate can be used as the heating unit 52. The temperature detecting unit 63 controls the heat amount which is applied to substrate 57 for bonding the sample 55 to substrate 57 after detecting the temperature of the sample 55. the light detecting unit 59 detects the light 54 which passes the sample 55, solder 56, and substrate 57, and transforms the light signal into an image signal.

A pyrometer or a thermocouple can be used as the temperature detecting unit 63, and a fluorescence single crystal plate which converts the light ray 54 into a two-dimensional image signal can be used as the light detecting unit 59.

The controlling unit 62 such as a computer receives the image signal and outputs it on a monitor, and transmits a control signal controlling the light source 51 and the heating unit 52. The controlling unit 62 outputs a signal controlling an optical intensity of the light ray 54 exiting the light source 51 and quantity of light emitted from the heating unit 52 according to the signal received in the temperature detecting unit 63.

In the monitoring system 50, the bonded status of the sample 55 is recognized based on a transmittance of the sample 55 which changes according to the status of a material in the sample 55, that is, absorption coefficient of the material when the X-ray transmits through the sample 55.

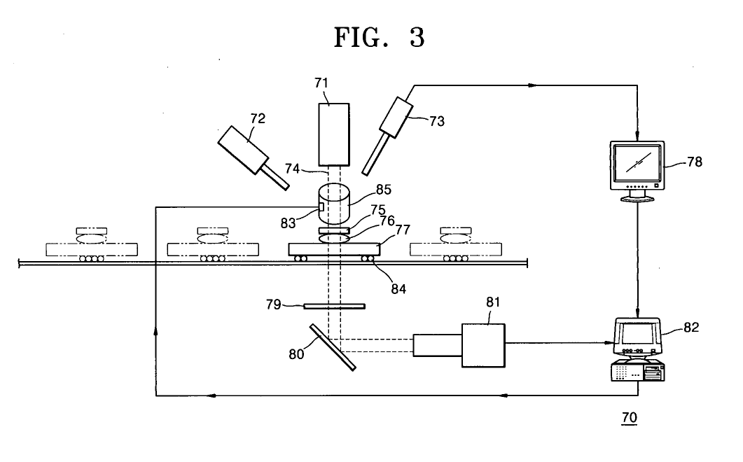

FIG. 3 is a block diagram of a monitoring system 70 according to another embodiment of the present invention. Referring to FIG. 3, the monitoring system 70 comprises a light source 71, a heating unit 72, a temperature detecting unit 83, a light detecting unit 79, a controlling unit 82, a supporter 84 for supporting a substrate 77, a first and second CCD cameras 73 and 81 for detecting a bonded status of the sample 75 to the substrate 77, and a mirror disposed on a light path between the light detecting unit 79 and the second CCD camera 81 to change the light path.

In contrast with the monitoring system 50, the monitoring system 70 further comprises a heat storage unit 85. The heat storage unit 85 is a temperature protection film covering the sample 55 so that the heat generated from the heating unit 72 can be transferred uniformly. The heat storage unit 85 is made of a material through which the light ray 74 such as the X-ray is able to transmit easily.

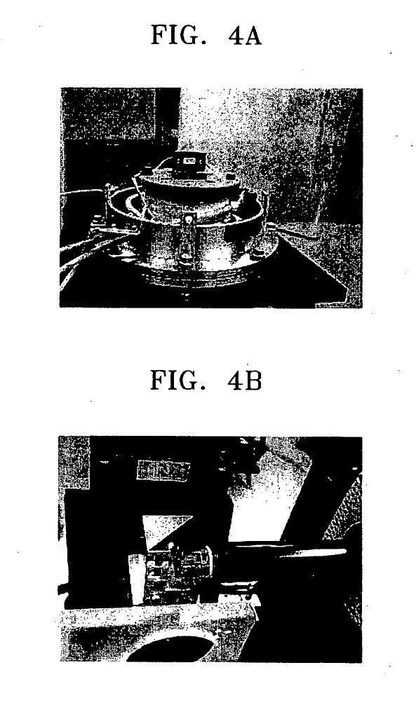

FIG. 4A is a photograph of the heat storage unit 72 in the monitoring system 70 of FIG. 3, and FIG. 4B is a photograph of the light detecting unit 79 and the second CCD camera 81 of the monitoring system 70 of FIG. 3.

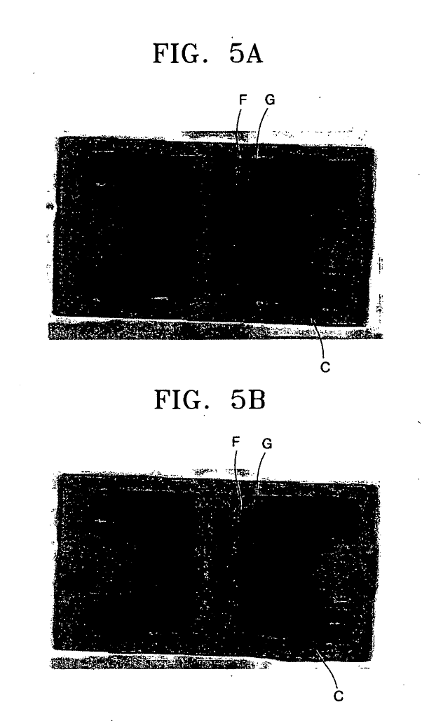

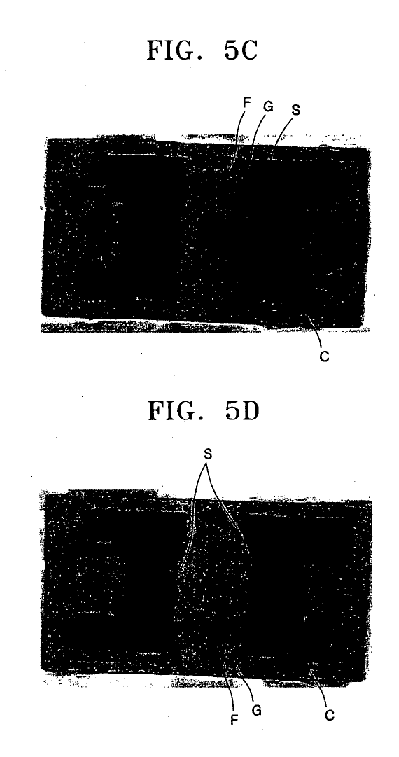

FIGS. 5A through 5D are photographs showing bonding states in a process of bonding an optical fiber (F) to a laser diode (LD) chip (C), the bonding process being monitored in real-time using the monitoring system 70. Changes of an inner status in the LD chip (C) are shown in FIG. 5A at room temperature, in FIG. 5B at 278° C., in FIG. 5C at 300° C., and in FIG. 5D at 315° C.

Referring to FIG. 5A, the optical fiber (F) is mounted on a groove (G). Referring to FIG. 5B, a solder (S) melts when the temperature of the LD chip (C) reaches 278° C. during the heating process to attach the optical fiber (F) on the substrate. Since the solder (S) remains in the groove (G), the bonding is fine.

However, referring to FIG. 5C, when the heating temperature reaches 300° C., the melted solder (S) expands toward the periphery of the optical fiber (F) out of the groove (G). In FIG. 5D, the solder (S) expands toward right and left sides of the groove (G), thereby degrading the bonding status of the LD chip (C).

From the real-time monitoring photographs FIGS. 5A through 5D, it can be concluded that the temperature suitable for bonding the optical fiber (F) to the LD chip (C) is about 278° C.˜300° C. As such, the apparition of a defect can be minimized by controlling the temperature in the manufacturing process of the LD chip (C).

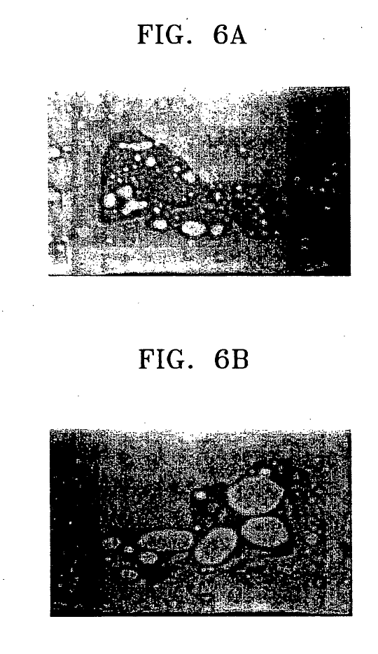

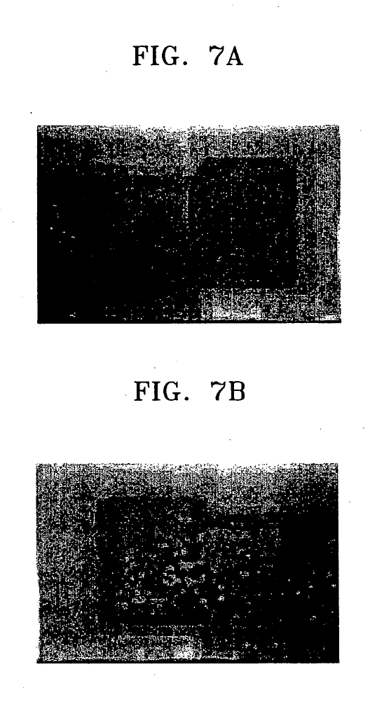

The in-situ monitoring system according to the present invention, has the advantage that a bonding process can be monitored in real-time determining whether or not air pores are formed in the bonded portion in the bonding process, thereby, reducing the apparition of defects. FIGS. 6A and 6B, and FIGS. 7A and 7B are real-time photographs taken during monitoring of the bonding process of the optical fiber (F) on a side of the LD chip (C) at a temperature of 280° C. FIGS. 6A and 7A show fine bonding states where relatively a small number of air pores are formed, and FIGS. 6B and 7B show defective states where relatively a large number of air pores are formed.

When a relatively small number of air pores exist in the bonded portion, the absorption coefficient of the bonded portion is different from that of the portion where the bonding is completed in a fine condition. Accordingly, less X-rays or ultrasonic waves are transmitted through the bonded portion. The number of rays is detected using the light detecting unit and reflected to recognize the state of the bonded portion.

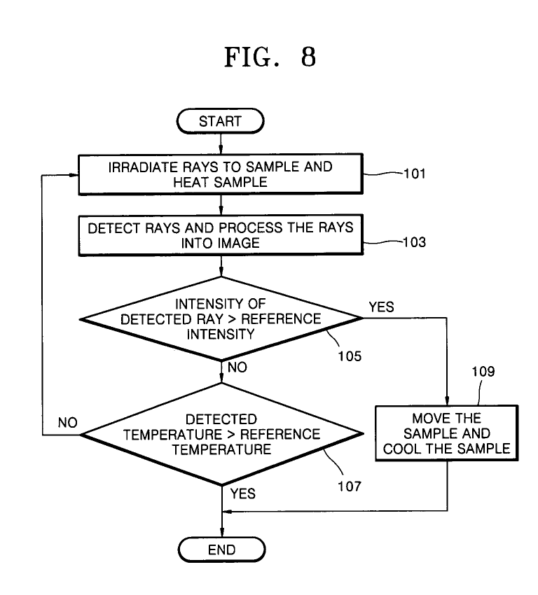

FIG. 8 is a flow chart illustrating a real time monitoring method according to an embodiment of the present invention. Before executing the real time monitoring method, a mark for aligning the sample is marked on the sample, and the position of the mark is inputted into the computer so that the aligning status of the sample can be monitored using the mark as reference data.

Referring to FIG. 8, rays are irradiated to detect changes of an inner status of the sample, and the sample is heated to be attached to the substrate (operation 101). Then, the rays passing through the sample are detected and processed into image (operation 103). The bonded status and the aligning status can be monitored in real-time from the image displayed on the monitor.

Next, an intensity of the detected rays is compared to an intensity of reference rays stored in the controlling unit (operation 105). When the intensity of detected rays is smaller than the reference intensity, a detected temperature is compared to a reference temperature (operation 107). When the detecting temperature is lower than the reference temperature, the process is performed again from operation 101. When the detecting temperature is higher than the reference temperature, a defect exists in the bonding, the algorithm stops, and the sample is discarded. When the intensity of detected rays is larger than the reference intensity in operation 105, the bonding of the sample is normal, and therefore, the sample is moved out of the monitoring system and cooled, and the algorithm is completed (operation 109).

In the monitoring system of the present invention, the bonded portion can be heated selectively to minimize the heat loss, the resolving power of the image is improved to minimize a defective proportion in the bonding, and defect feedback can be performed in real-time.

That is, optimal heating condition and optimal bonding structure can be achieved by monitoring the start temperature of the bonding process, bonding position, and deformation of solder using the monitoring system and the monitoring method according to the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An in-situ monitoring system comprising:
a light source irradiating rays to a sample;
a heating unit heating the sample;
a temperature detecting unit detecting the temperature of the sample;
a light detecting unit detecting the rays passing through the sample and converting the rays into an image signal; and
a controlling unit receiving and outputting the image signal, and transmitting a signal for controlling the light source and the heating unit.

2. The system of claim 1, wherein the light source emits X-rays or ultrasonic waves.

3. The system of claim 1, wherein the heating unit is one of laser, hot wire, and heating plate.

4. The system of claim 1, wherein the temperature detecting unit is a pyrometer or a thermocouple.

5. The system of claim 1, wherein the light detecting unit is a fluorescence single crystal plate.

6. The system of claim 1, wherein the controlling unit is a computer.

7. The system of claim 1, further comprising a supporter for supporting the substrate.

8. The system of claim 1, further comprising a heat storage unit covering around the sample.

9. An in-situ monitoring method comprising:
(a) irradiating rays to a sample, and bonding the sample to a substrate by heating the sample; and
(b) detecting and imaging the ray passing through the sample, and monitoring the bonding status by detecting an intensity of the rays and a temperature of the sample.

10. The method of claim 9, further comprising (c) controlling the intensity of the ray and the temperature of the sample after monitoring the bonding status in operation (b).

11. The method of claim 9, wherein the ray is X-rays or ultrasonic waves.

12. The method of claim 9, wherein operation (b) comprises:
comparing the temperature of sample to a reference temperature when the intensity of the ray is smaller than the reference intensity, and moving the sample outward and cooling the sample when the intensity of the ray is the reference intensity or larger; and
repeating the process from step (a) when the temperature of the sample is lower than the reference temperature, and moving the sample outward and discarding the sample when the temperature of the sample is the reference temperature or higher.

13. The method of claim 9, wherein the sample is heated using one of a laser, a hot wire, and a heating plate.

14. The method of claim 9, wherein the temperature of sample is detected using a pyrometer or thermocouple.

15. The method of claim 9, wherein the ray is detected using a fluorescence single crystal plate.

16. The method of claim 10, wherein the intensity of the ray and the temperature of sample is controlled using a computer.

17. The method of claim 9, further comprising preparing a supporter for supporting the substrate.

18. The method of claim 9, further comprising preparing a heat storage unit surrounding the sample.
